(19) United States
(12) Patent Application Publication
(10) Pub. No.: US 2008/0181310 A1
(43) Pub. Date: Jul. 31, 2008

(54) MOTION SEARCH METHOD AND APPARATUS FOR MINIMIZING OFF-CHIP MEMORY ACCESS

(76) Inventors: Kwang-Pyo CHOI, Anyang-si (KR); Young-Hun Joo, Yongin-si (KR); Bong-Gon Kim, Seoul (KR); Yun-Je Oh, Yongin-si (KR); Byeungwoo Jeon, Seongnam-si (KR); Bongsoo Jung, Yeonje-gu (KR)

Correspondence Address: CHA & REITER, LLC, 210 ROUTE 4 EAST STE 103, PARAMUS, NJ, 07652, US

(21) Appl. No.: 12/018,901

(22) Filed: Jan. 24, 2008

(30) Foreign Application Priority Data
Jan. 26, 2007 (KR) 8387 2007

(51) Int. Cl. H04N 7/26

(52) U.S. Cl. 375/240.16; 375/E07.125

(57) ABSTRACT

A motion search method and apparatus for minimizing an off-chip memory access to reduce cycles for predicting a motion vector. A sum of absolute differences (SAD) calculation processing is performed, while an off-chip memory is accessed using Direct Memory Access (DMA). A position of a current macro block is determined if a frame is input and the length of a horizontal search line is set according to adjacent motion vectors and predetermined external parameters. The SADs are calculated by calculating medians of the adjacent motion vectors as a predictive motion vector, setting a vertical direction value of the predictive motion vector as an initial search line, and sequentially searching at least one horizontal search line, and determining a position of a minimum SAD from the at least one horizontal search line. The minimum SAD position is selected as a final motion vector.

### CLAIM OF PRIORITY

This application claims the benefit of priority under 35 U.S.C. § 119(a) from a Patent Application filed in the Korean Intellectual Property Office on Jan. 26, 2007 and assigned Serial No. 2007-08387, the contents of which are incorporated herein by reference in its entirety.

### BACKGROUND OF THE INVENTION

1. Field of the Invention

The present invention relates generally to media processing of motion prediction for image compression technology. More particularly, the present invention relates generally to a motion search method and apparatus for minimizing an off-chip memory access.

2. Description of the Related Art

In the case of digital image data used in many applications, including but in no way limited to video conferencing, High Definition Television (HDTV), Video On Demand (VOD) receivers, Personal Computers (PCs) supporting Moving Picture Experts Group (MPEG) images, game tools, terrestrial digital broadcasting receivers, digital satellite broadcasting receivers, Cable Television (CATV), etc., since an amount of data significantly increases due to the characteristics of the digital image data, particularly when digitizing an analog signal, the digital image data is compressed using an efficient compression method.

For image compression technology, there are compression standards, some examples of which are MPEG, H.26x, and the like, and these image compression schemes are typically used for various applications, including but not limited video players, VOD, video call, DMB, and so on. In addition, according to the development of wireless communication, such as 2.5 G and 3 G, image transmission in a wireless mobile base is being commercialized.

In General, there are three kinds of image data compression methods. These are: i) a temporal redundancy reducing method; ii) a spatial redundancy reducing method; and iii) a statistical characteristic of code utilizing method. For example, the use of a motion estimation and compensation method is a representative example of the temporal redundancy reducing method.

Although high coding efficiency has been achieved by eliminating temporal redundancy in moving picture encoding, due to the fact that a motion search needs the largest amount of computation for performing moving picture encoding, the ability to process the motion search quickly becomes an important technical problem. A Sum of Absolute Difference (SAD) is most widely utilized as a block matching error evaluation criterion in order to determine a best matched position in most block matching motion searches and is represented by Equation 1.

$$SAD ( x , y ) = {\sum }_{m = 0}^{M - 1} {\sum }_{n = 0}^{N - 1} \vert s ( m , n ) - r ( m + x , n + y ) \vert , \\ - P \leq ( x , y ) \leq P \qquad ( 1 )$$

With regard to equation (1) above, s(m,n) denotes a current block for motion estimation, r(m,n) denotes a block for calculating a SAD in a reference image, M and N respectively denote horizontal and vertical sizes of each block, and P denotes a search window size. When a SAD is smallest, (x,y) of the SAD is referred to as an optimal motion vector.

Moreover, the simplest optimal motion vector search method is a Full Search Block-Matching Algorithm (FSBMA), which calculates SADs of all (x,y) positions in a search area and determines (x,y) having the smallest SAD.

In addition, the FSBMA needs a great amount of computation due to a high memory bandwidth and a frequent SAD calculation, if the FSBMA is applied to hardware without any change, because many Processing Elements (Pes) are needed for real-time implementation.

In general, known high-speed motion search methods decrease the number of search points in a search area in order to reduce the large amount of SAD computation of the FSBMA. However, these methods have many problems with implementation in a media processor and/or hardware for performing SAD computations at high speed because complex judgment sentences and abnormalized data are referred to in order to reduce the number of search points.

There are some high-speed block matching motion search methods that reduce an amount of SAD computation caused by the relatively large number of search points. Three such high-speed block matching motion search methods include a three step search method, a diamond search method, and a hexagon-based search method. FIGS. 1A and 1B illustrate a diamond search pattern according to a conventional high-speed block matching motion search method.

As illustrated in FIGS. 1A and 1B, in the diamond search method, which is one representative type of conventional search method, there are two search patterns, and when an image is represented with an x-y coordinate system in order to search for an optimal motion vector in a reference image with respect to a selected block, the diamond search method searches for a point having the minimum SAD by starting from a point having a motion vector of (0, 0). In order to perform the aforementioned, in the diamond method a point having the minimum SAD is searched for from among 9 points adjacent to the central point of a big diamond search pattern, such as illustrated in FIG. 1A, which is set to (0, 0). The same process is repeated by newly setting the found point as the central point of a new big diamond search pattern.

Still referring to FIG. 1A, this process is repeated until a point having the minimum SAD becomes the central point of a new big diamond search pattern. If a point having the minimum SAD becomes the central point of a big diamond search pattern, a point having the minimum SAD is searched for once more by setting the point as the central point of a small diamond search pattern, as illustrated in FIG. 1B, and the found point is determined as the optimal motion vector.

FIGS. 2A and 2B illustrate a hexagon-based search pattern according to a conventional high-speed block matching motion search method. As illustrated in FIGS. 2A and 2B, the hexagon-based search method operates the same way as the diamond search method except for a change from the diamond shape to the hexagonal shape.

These conventional motion search methods gradually search for a position having the minimum matching error by repeatedly performing a search in a search area using a specific search pattern, and there methods operate on the principle that an amount of SAD computation is reduced by decreasing the number of search points. However, the aforementioned conventional motion search methods have a drawback in that it is easy to obtain a local minimum value in an image having a complex and great motion, thereby resulting in a degradation of image quality and degradation of a compression ratio.

In general, reducing an amount of SAD computation based on three arithmetic operations, such as SUB, ADD, and ABS shown in Equation 1, can be effective in reducing the amount of computations required for a motion search. However, when this method is implemented as a media processor or in other hardware, the number of cycles needed for SAD computation of a single motion position can be ultimately reduced by using a SAD accelerator or parallel processing a plurality of pixels in order to perform the SAD computation. On the other hand, there are many cycles needed to access a reference image stored in an off-chip memory. This means that when a media processor or other hardware is used, reducing the number of search points as in a conventional motion search method is not the major concern for reducing an amount of computation. Rather, the reduction in an off-chip memory access for SAD computation becomes one of the biggest concerns when attempting to increase the speed of a motion search.

Accordingly, in order for more effective parallel processing during a motion search algorithm, the dependency on a search pattern should be relatively low, and complexity due to the use of a complex control command should also be low. However, in conventional high-speed motion search methods a subsequent search point is dependent on a current search result, (such as the diamond search method), and therefore data of the subsequent search point cannot be obtained in advance. Therefore, there is a great deal of difficulty in implementing the conventional high-speed motion search methods as a media processor or by other hardware, and such methods have a relatively complex control command structure.

Thus, only with a normalized search pattern, can SADs of a plurality of points can be calculated by reducing an off-chip memory access in a media processor or implemented hardware and effectively reusing data in an on-chip memory.

Meanwhile, a Predictive Line Search (PLS) method has been developed in an effort to reduce an off-chip memory access and effectively reuse an on-chip memory in a media processor. The PLS method will now be described in detail. Assuming that a horizontal line having a search area size, which passes a predictive motion vector point, is p, all positions in three lines, i.e. p−1, p, and p+1, are examined. An additional line is also examined in a direction having the minimum SAD. If a point having the minimum SAD is not located on the center line of the three examined lines, the line search is continuously performed. When the point having the minimum SAD is found from the center line of three examined lines, the line search ends, and the point is selected as an optimal motion vector. Thus, the PLS method reduces an off-chip memory access by effectively reusing data on a single horizontal line. However, there is a problem with the PLS method as it sets a horizontal line size to a horizontal size of a search window for all macro blocks, frequently causing the occurrence of unnecessary off-chip memory access even for images having a small motion, blocks having high correlations with motion vectors of adjacent blocks, and background images.

### SUMMARY OF THE INVENTION

An exemplary aspect of the present invention is to solve in part at least some of the above problems and/or disadvantages and to provide at least the advantages described herein below. Accordingly, an exemplary aspect of the present invention is to provide a method and apparatus for increasing a search speed by adaptively setting the size of a horizontal search line by referring to adjacent motion vectors while using a search pattern of a Predictive Line Search (PLS) method, reading reference memory data of a horizontal line using a memory access method, such as Direct Memory Access (DMA), enabling parallel processing of a memory access and a SAD (sum of absolute difference) calculator, and significantly reducing an off-chip memory access by processing the reference memory data of the horizontal line in an on-chip memory.

According to one aspect of the present invention, there is provided an exemplary motion search method for minimizing an off-chip memory access in memory access processing and SAD (sum of absolute difference) calculation processing, wherein an off-chip memory is accessed using Direct Memory Access (DMA) while SAD calculation is performed, the method may typically comprise: if a frame is input, determining a position of a current macro block and setting the length of a horizontal search line according to adjacent motion vectors and predetermined external parameters; calculating SADs by calculating medians of the adjacent motion vectors as a predictive motion vector, setting a vertical direction value of the predictive motion vector as an initial search line, and sequentially searching at least one horizontal search line; and determining a position of a minimum SAD from the at least one horizontal search line, and if the minimum SAD is located on the center line of the at least one horizontal search line, ending the motion search and selecting the minimum SAD position as a final motion vector.

### BRIEF DESCRIPTION OF THE DRAWINGS

The above examples as well as other examples of objects, features and advantages of the present invention will become more apparent from the following detailed description when taken in conjunction with the accompanying drawing in which:

FIG. 1 illustrates a diamond search pattern according to a conventional high-speed block matching motion search method;

FIG. 2 illustrates a hexagon-based search pattern according to a conventional high-speed block matching motion search method;

FIG. 3 is a block diagram of an exemplary video encoding device including a motion search apparatus which can be used with the present invention;

FIG. 4 is a block diagram of a motion search apparatus according to an exemplary embodiment of the present invention;

FIG. 5 illustrates motion vectors of adjacent blocks in a motion search apparatus according to an exemplary embodiment of the present invention;

FIG. 6 illustrates the use of an on-chip memory when a SAD (sum of absolute difference) is calculated by copying a single horizontal line in a motion search apparatus according to an exemplary embodiment of the present invention;

FIG. 7 illustrates a line search sequence for performing memory access processing and SAD calculation processing by accessing an off-chip memory using Direct Memory Access (DMA) while performing the SAD calculation processing according to an exemplary embodiment of the present invention;

FIG. 8 is a flowchart of a motion search method according to an exemplary embodiment of the present invention; and

FIG. 9 illustrates a final motion according to the motion search method illustrated in FIG. 8.

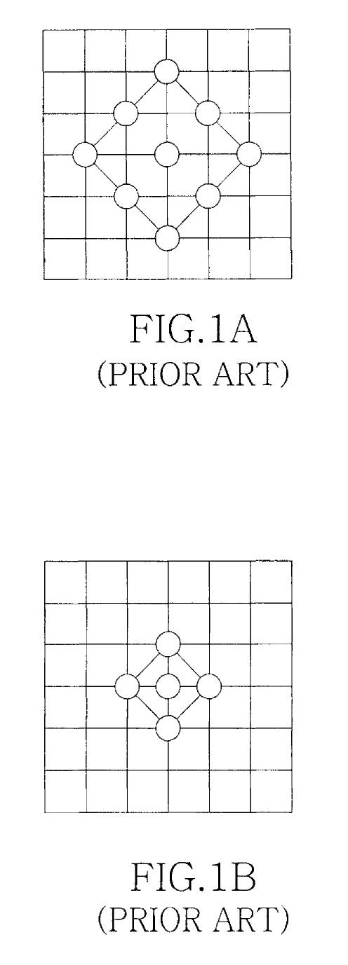

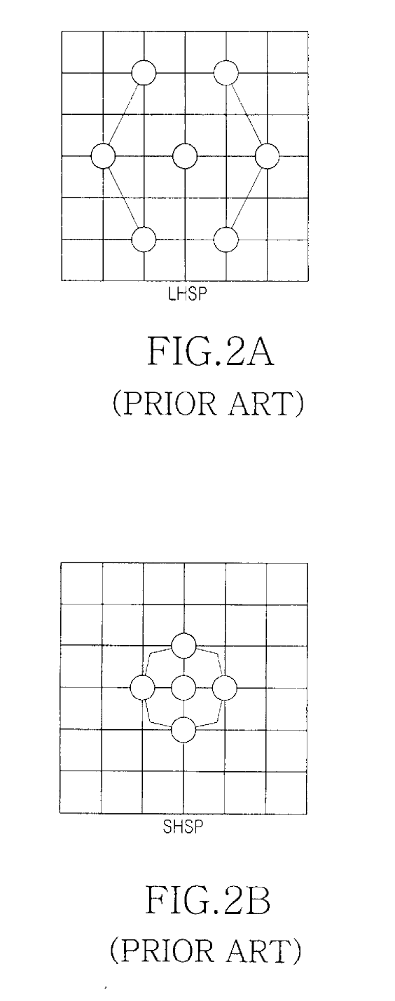

### DETAILED DESCRIPTION OF THE INVENTION

Now, embodiments of the present invention will be described herein below with reference to the accompanying drawings. In the drawings, the same or similar elements are denoted by the same reference numerals even though they are depicted in different drawings. The invention is not limited to the examples shown and described herein, with the depictions provided for illustrative purposes. For the purposes of clarity and simplicity, well-known functions or constructions may not be described in detail when a description of such well-known functions or constructions would obscure appreciation of the invention by a person of ordinary skill in the art.

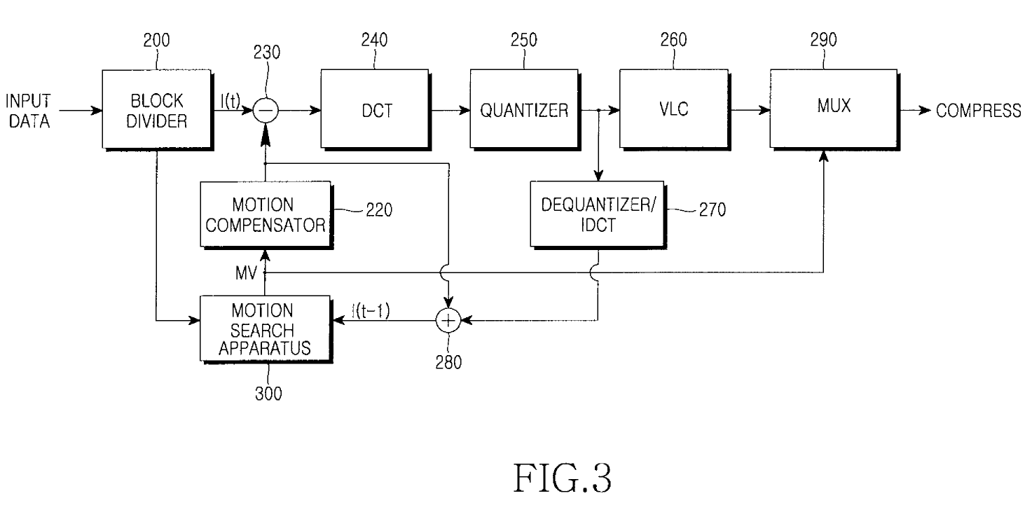

FIG. 3 is a block diagram of a video encoding device including a motion search apparatus 300 that can be used with the present invention. A process of compressing an input video signal will now be described in detail with reference to FIG. 3. A block divider 200 divides every frame of input video into blocks. A subtractor 230 subtracts a current frame from an output of a motion compensator 220, a Discrete Cosine Transformer (DCT) 240 transforms an output of the subtractor 230, and a quantizer 250 quantizes transformed coefficients. A variable length coder (VLC) 260 generates a compressed stream from a quantized result. A dequantizer/inverse DCT (IDCT) 270 and an adder 280 restore an input image to an original image, and the motion search apparatus 300 searches or predicts a motion of the current frame using the restored image (a previous image).

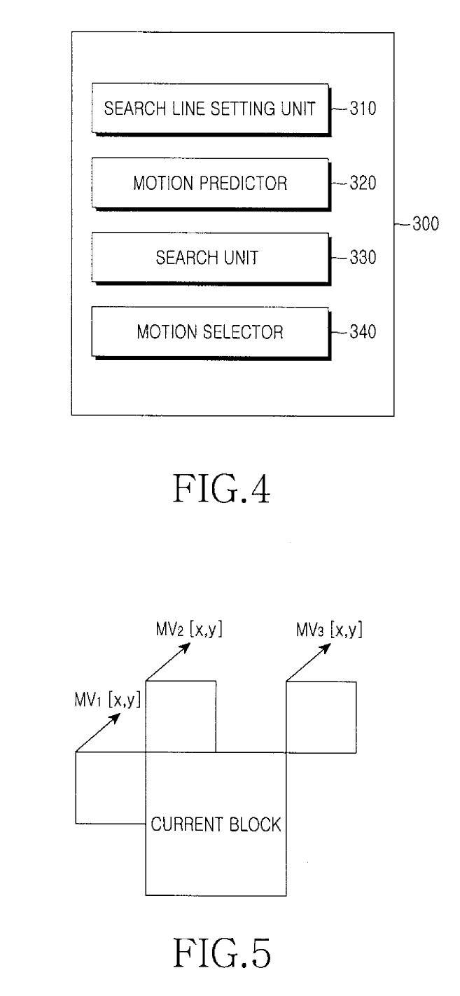

FIG. 4 is a block diagram providing details of the motion search apparatus 300 according to an exemplary embodiment of the present invention. Referring to FIG. 4, the motion search apparatus 300 includes a search line setting unit 310, a motion predictor 320, a search unit 330, and a motion selector 340.

If a frame is input into block divider 200 and is typically divided into macro blocks, the search line setting unit 310 of the motion search apparatus 300 determines whether a position of a current macro block is a first position in both horizontal and vertical directions of the frame. If the position of the current macro block is the first position in the horizontal and vertical directions of the frame, then the search line setting unit 310 sets a horizontal search line length as a horizontal size of a search window. However, if the position of the current macro block is the not the first position in the horizontal and vertical directions of the frame, the search line setting unit 310 then sets the horizontal search line length using adjacent motion vectors.

The motion predictor 320 obtains a predictive motion vector from vertical and horizontal medians of the adjacent motion vectors in order to select a search line starting point.

The search unit 330 calculates a SAD (sum of absolute difference) by setting a vertical direction value of the predictive motion vector as an initial search line, and by sequentially searching search lines.

The motion selector 340 determines a search line on which a minimum SAD is located from among the search lines and selects a minimum SAD position as a final motion vector based on the search line on which the minimum SAD is located.

FIG. 5 illustrates an example of motion vectors of adjacent blocks in a motion search apparatus according to an exemplary embodiment of the present invention.

Referring to the example shown in FIG. 5, a predictive motion vector is obtained from vertical and horizontal medians of motion vector values, and a horizontal search line length is determined by referring to horizontal component values of adjacent motion vectors. An example of one way to determine the horizontal search line length is represented by Equations 2 and 3,

max_{—}xx=max(MV₁(x),MV₂(x),MV₃(x))

min_{—}xx=min(MV₁(x),MV₂(x),MV₃(x)) (2)

h_size=min(((max_{—}xx−min_{—}xx+1)>>1)+D,SR) (3)

In equations (2) and (3) above, max_xx denotes the maximum value of horizontal components of adjacent motion vectors based on a 16×16 block size, min_xx denotes the minimum value of the horizontal components of the adjacent motion vectors, and SR denotes a horizontal search window size.

In addition, h_size is an element for determining a horizontal search line length as a smaller value between a value obtained by adding an offset D to a half of a value obtained by subtracting the minimum horizontal component of the adjacent motion vectors from the maximum horizontal component and SR.

Consequently, a horizontal search performs a memory access and search by an amount of ±h_size from the predictive motion vector, The offset D is a value flexibly used by a user, and as an example, when using a Texas Instruments™ Model TI C6416 Digital Signal Processor (DSP), since C6416 uses a 64-bit bus as an on-chip memory, when data stored in an off-chip memory is transferred to the on-chip memory, if memory alignment is achieved on an 8-byte basis, the off-chip memory can be accessed at a higher rate due to a transmission rate of a multiple number of 8-bytes.

Thus, according to the present invention, a high-speed memory access can be achieved by adjusting the offset D so that the horizontal search line length is aligned on an 8-byte basis. For example, if max_xxx=4, min_xx=1, and D=0, h_size=2 and the horizontal search line length is 5. Then, a memory access in a reference frame is achieved by an amount of 20 (5+15) bytes, and this does not correspond to the 8-byte alignment in the example of C6416 DSP. If the offset D is adjusted to 2, the horizontal search line length becomes 9, and the reference frame access is achieved by an amount of 24 (9+15) bytes, corresponding to the 8-byte alignment. In this way, high-speed DMA access can be achieved.

In Equation 3, h_size is small as a correlation between the adjacent motion vectors is high and high as the correlation is low. Another example determining the horizontal search line length is represented by Equation (4).

h_size=min((max_{—}xx+D),SR) (4)

The offset D in Equation 4 is also flexibly determined by a user for efficiency of memory access and improvement of search performance.

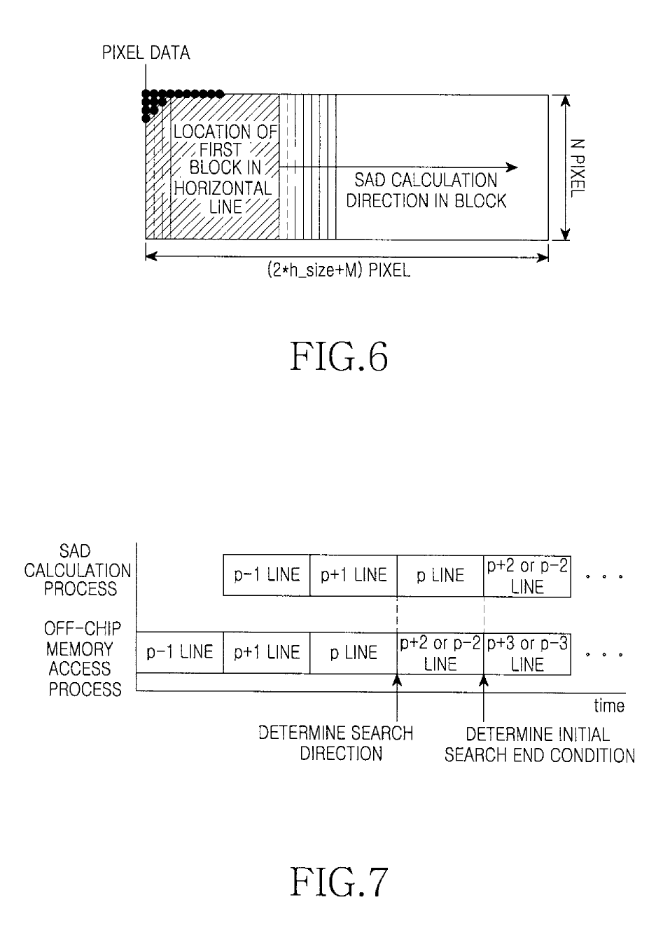

FIG. 6 illustrates the use of an on-chip memory when a SAD is calculated by copying a single horizontal line in a motion search apparatus according to an exemplary embodiment of the present invention.

Referring to FIG. 6, in order to increase on-chip memory use efficiency, a search is sequentially performed from left to right in the stored order by copying data from an off-chip memory to the on-chip memory by an amount of (2×h_size+M)×N, wherein M and N respectively denote magnitude of an x-axis and magnitude of a y-axis of a current block for which the search is performed. According to the current exemplary embodiment illustrated in FIG. 6, in order to search a single horizontal line, after calculating an SAD of a first block in the on-chip memory, a SAD of a subsequent block is calculated by horizontally moving one pixel in the on-chip memory without accessing the off-chip memory.

In addition, due to a normalized pattern on a search line, a suggested scheme can increase the parallelness of commands in a media processor having a Very Long Instruction Word (VLIW) or a superscalar architecture,

Meanwhile, an existing high-speed search pattern needs a 256 (16×16)-byte off-chip memory access in order to calculate a SAD of a single search point. Comparing to an existing high-speed search method needing a 256-byte off-chip memory access for a single search position, one advantage of a high-speed motion search according to the current embodiment is that it can be performed with only a very small off-chip memory access.

Therefore, if it is assumed that a horizontal search window size is 16 in order to compare the current exemplary embodiment with an existing PLS method in which on-chip memory use efficiency is increased, since the existing PLS method searches all positions of a single horizontal line within a search area, the existing PLS method needs a 768 ((2×16+1+15)×16)-byte memory access. This type of search (all positions of a single horizontal line within a search area) is effective in a case where a great motion occurs in the horizontal direction. However, in the case where the amount of motion is relatively small, or if a correlation with adjacent motion vectors is relatively high, or in a case of a background image, an unnecessarily large off-chip memory access occurs.

However, since the current exemplary embodiment adaptively determines a search line size according to adjacent motion vectors, a search is performed with a relatively small search line for an image having a small amount of motion, and a relatively larger search line for an image having a larger amount of motion. In a case where correlations between adjacent motion vectors are low, a search is performed with a larger search line, thereby increasing memory access efficiency and motion search accuracy.

FIG. 7 illustrates a line search sequence for performing memory access processing and SAD calculation processing by accessing an off-chip memory using DMA while performing the SAD calculation processing according to an exemplary embodiment of the present invention.

As illustrated in the example shown in FIG. 7, if the initial order of search lines comprises a (p−1) line, a (p+1) line, and a p line, a SAD calculation process and an off-chip memory access process can be fully parallel-processed. In other words, in the search order of the (p−1) line, the (p+1) line, and the p line, by searching the (p−1) line and the (p+1) line in advance, it can be determined before the p line is searched in which vertical line direction the search proceeds in. According to this example of the present invention, parallel processing can be performed so that the p line is searched and data is simultaneously read from the off-chip memory in the pre-determined direction ((p−1) or (p+1) direction). Here, the search order of the (p−1) line and the (p+1) line can be exchanged.

Thus, when a DMA is used, if it is assumed that off-chip memory access cycles are equal to SAD calculation cycles for a single line, the cycles required for a motion search are taken by (p−1) line access cycles and the number of search lines, i.e., further taken by the SAD calculation process. This means that DMA is generally very effective for a media process or DSP using a local memory architecture.

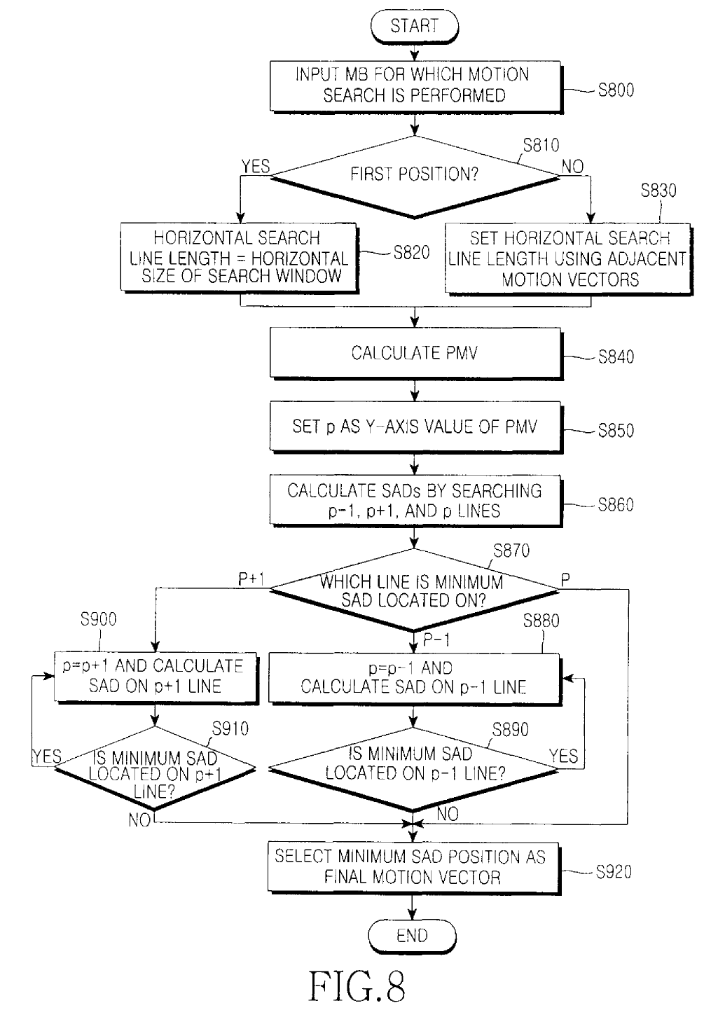

FIG. 8 is a flowchart illustrating exemplary steps of a motion search method according to an exemplary embodiment of the present invention. The apparatus in FIG. 4 can be used in conjunction with the method described herein below.

Referring to the example shown in FIG. 8, if a frame is input to the motion search apparatus 300 in step S800, the search line setting unit 310 determines in step S810 whether a current macro block is located at a first position of the frame in both horizontal and vertical directions.

If it is determined in step S810 that the current macro block is located at the first position of the frame in both horizontal and vertical directions, a horizontal search line length then becomes a horizontal size of a search window in step S820. If it is determined in step S810 that the current macro block is not located at the first position of the frame in both horizontal and vertical directions, then the horizontal search line length is determined using adjacent motion vectors in step S830.

The motion predictor 320 (shown in FIG. 4) calculates a Predictive Motion Vector (PMV) using medians of vertical and horizontal values of the adjacent motion vectors in step S840.

The search unit 330 (also shown in FIG. 4) sets a vertical value (typically a Y-axis value) of the PMV as an initial search line p in step S850 and typically calculates SADs by sequentially searching (p−1), (p+1), and p lines in step S860.

The motion selector 340 determines in step S870 which line (e.g., the (p−1) line, the (p+1) line, or the p line) a minimum SAD is located on. If it is determined in step S870 that the minimum SAD is located on the p line, the motion search ends and a position of the minimum SAD is selected as a final motion vector in step S920.

If it is determined in step S870 that the minimum SAD is located on the (p−1) line, p is replaced with (p−1) and SADs of all positions of a new (p−1) line are calculated in step S880. If a minimum SAD is located on the new (p−1) line in step S890, step S880 is repeated, otherwise a position of the minimum SAD is selected as a final motion vector in step S920.

If it is determined in step S870 that the minimum SAD is located on the (p+1) line, p is replaced with (p+1) and SADs of all positions of a new (p+1) line are calculated in step S900. If a minimum SAD is located on the new (p+1) line in step S910, step S900 is repeated, otherwise a position of the minimum SAD is selected as a final motion vector in step S920.

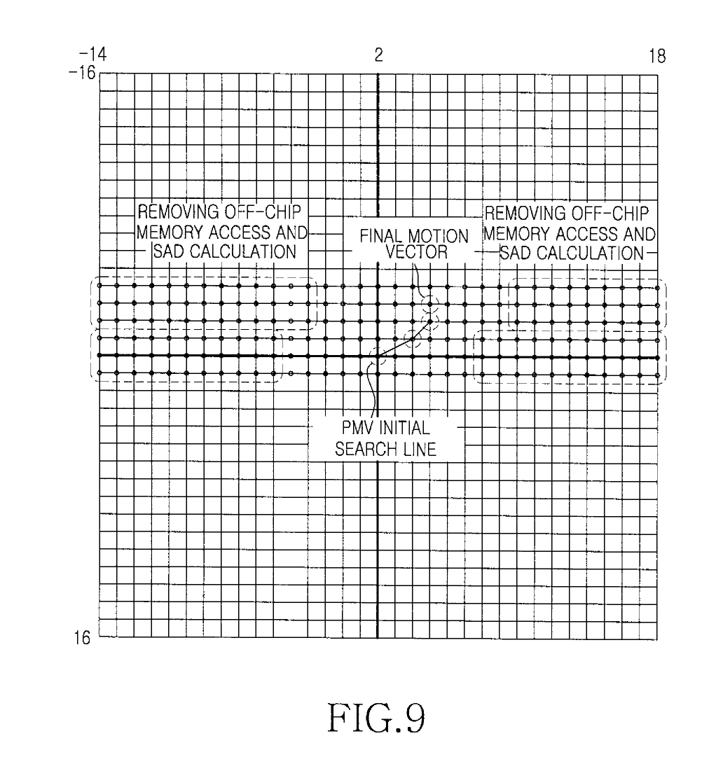

FIG. 9 illustrates a final motion according to the exemplary motion search method according to the present invention illustrated in FIG. 8.

Referring to FIG. 9, if it is assumed that motion vectors of adjacent blocks are (0, 2), (3, −1), and (2, 0), a PMV (x, y) is (2, 0), and h_size is 5 when D is 1 in Equations 2 and 3. It is also assumed that an optimal motion vector is (5, −3) and a horizontal search window size is 16. A p line is within a +/−5 horizontal range of a search area located at y=0, and three lines to be searched are a −1 (p−1) line, a 1 (p+1) line, and a 0 (p) line. Then, a minimum SAD point is (4, −1). Since the −1 line on which the minimum SAD point is located is a boundary line among the three search lines, a −2 line is additionally searched. Here, a horizontal line is within a +/−5 horizontal range based on x=4. A new minimum SAD point is (5, −2). This point is still located on a boundary line among three new search lines.

Thus, a −3 line is additionally searched. As a result, a new minimum SAD point is (5, −3), and since this point is still located on a boundary line among three new search lines, a −4 line is additionally searched. As a result, a new minimum SAD point is (5, −3). Since this point is not located on a boundary line, the point (5, −3) is selected as an optimal motion vector.

In other words, if it is assumed that a horizontal line having a search area size, which passes through a PMV point is p, all positions in three lines (p−1), (p+1), and p are searched.

According to the example described herein, an additional line is searched in a direction in which a minimum SAD point is located. If the minimum SAD point is not located on a center line among the three search lines, the line search is continuously performed. When a minimum SAD point is located on a center line, the search ends, and the minimum SAD point is selected as an optimal motion vector.

The PLS method according to the present invention increases coding efficiency by using correlations between spatial motion vectors as compared to conventional center-biased methods and decreases an off-chip reference memory access time by effectively reusing data in a single horizontal line within a search area, resulting in improved performance in terms of speed.

As described above, according to the present invention, in a system having a limited on-chip memory, by calculating a SAD by reducing an off-chip memory access and reusing data in an on-chip memory, and by fully parallel processing the SAD calculation and the off-chip memory access using an architecture, such as DMA, for effectively accessing an off-chip memory, the number of cycles required to predict a motion vector can be reduced, and accuracy of the motion vector prediction can be increased.

While the invention has been shown and described with reference to a certain preferred exemplary embodiments thereof, it will be understood by those skilled in the art that various changes in form and details may be made therein without departing from the spirit of the invention and the scope of the appended claims. One example is while the description discloses that the search unit performs the search from left to right by copying at least one horizontal line from the off-chip memory to an on-chip memory, the reading could also occur from right to left, and it could alternate directions.

What is claimed is:

1. A motion search method for minimizing an off-chip memory access in memory access processing and SAD (sum of absolute difference) calculation processing, wherein an off-chip memory is accessed using Direct Memory Access (DMA) while SAD calculation is performed, the method comprising:
(a) determining a position of a current macro block and setting a length of a horizontal search line according to adjacent motion vectors and predetermined external parameters when a frame is input;
(b) calculating a plurality of SADs by calculating medians of the adjacent motion vectors as a predictive motion vector, setting a vertical direction value of the predictive motion vector as an initial search line, and sequentially searching at least one horizontal search line; and
(c) determining a position of a minimum SAD from said at least one horizontal search line searched in step (b).

2. The method of claim 1, wherein if the minimum SAD is located on the center line of said at least one horizontal search line, ending the motion search and selecting the minimum SAD position as a final motion vector.

3. The method of claim 2, wherein said at least one horizontal search line comprises two or more horizontal search lines, and said method further comprising performing parallel processing so that data of another horizontal search line is read from the off-chip memory while calculating an SAD from said at least one horizontal search line.

4. The method of claim 1, further comprising setting the horizontal search line length as a horizontal size of a search window if it is determined that the current macro block is located at a first position.

5. The method of claim 1, further comprising adaptively setting the horizontal search line length using the adjacent motion vectors, if it is determined that the current macro block is not located at the first position.

6. The method of claim 4, wherein the horizontal search line length is set according to the following equation:
max_{—}xx=max(MV₁(x),MV₂(x),MV₃(x))
min_{—}xx=min(MV₁(x),MV₂(x),MV₃(x))
h_size=min(((max_{—}xx−min_{—}xx+1)>>1)+D,SR);
wherein max_xx denotes a maximum value of horizontal components of adjacent motion vectors based on a 16×16 block size, min_xx denotes the minimum value of the horizontal components of the adjacent motion vectors, and SR denotes a horizontal search window size, h_size comprises an element for determining a horizontal search line length as a smaller value between a value obtained by adding an offset D to a half of a value obtained by subtracting the minimum horizontal component of the adjacent motion vectors from the maximum horizontal component and SR.

7. The method of claim 1, wherein the horizontal search line length is shorter as correlations between the adjacent motion vectors are higher and the horizontal search line length is longer as the correlations are lower.

8. The method of claim 5, wherein the horizontal search line length is represented by the equation below
h_size=min((max_{—}xx+D),SR);
wherein max_xx denotes a maximum value of horizontal components of adjacent motion vectors based on a 16×16 block size, min_xx denotes the minimum value of the horizontal components of the adjacent motion vectors, and SR denotes a horizontal search window size, h_size comprises an element for determining a horizontal search line length as a smaller value between a value obtained by adding an offset D to a half of a value obtained by subtracting the minimum horizontal component of the adjacent motion vectors from the maximum horizontal component and SR.

9. The method of claim 1, wherein the search is performed from left to right by copying at least one horizontal line from the off-chip memory to an on-chip memory.

10. The method of claim 1, further comprising if the minimum SAD is not located on the center line of the at least one horizontal search line, repeatedly performing the line search.

11. The method of claim 2, further comprising if the minimum SAD is not located on the center line of the at least one horizontal search line, repeatedly performing the line search.

12. The method of claim 1, wherein the SAD calculation is performed at a location horizontally moved by 1 pixel in the on-chip memory after calculating the SADs of the current macro block.

13. A motion search apparatus for minimizing an off-chip memory access in memory access processing and SAD (sum of absolute difference) calculation processing, wherein an off-chip memory is accessed using Direct Memory Access (DMA) while SAD calculation is performed, the apparatus comprising:
a search line setting unit for determining a position of a current macro block and for setting the length of a horizontal search line according to adjacent motion vectors and predetermined parameters;
a motion predictor for calculating a predictive motion vector using medians of the adjacent motion vectors in order to select a starting point of the horizontal search line;
a search unit for calculating SADs by setting a vertical direction value of the predictive motion vector as an initial search line and for sequentially searching at least one horizontal search line; and
a motion selector for determining a position of a minimum SAD from the at least one horizontal search line and for selecting a final motion vector according to the position.

14. The apparatus of claim 13, wherein data of another horizontal search line is read from the off-chip memory while said search unit calculates a SAD from one horizontal search line.

15. The apparatus of claim 13, wherein the search line setting unit adaptively sets the horizontal search line length using the adjacent motion vectors.

16. The apparatus of claim 15, wherein the horizontal search line length is represented by the equation below
max_{—}xx=max(MV₁(x),MV₂(x),MV₃(x))
min_{—}xx=min(MV₁(x),MV₂(x),MV₃(x))
h_size=min(((max_{—}xx−min_{—}xx+1)>>1)+D,SR)
wherein max_xx denotes a maximum value of horizontal components of adjacent motion vectors based on a 16×16 block size, min_xx denotes the minimum value of the horizontal components of the adjacent motion vectors, and SR denotes a horizontal search window size, h_size comprises an element for determining a horizontal search line length as a smaller value between a value obtained by adding an offset D to a half of a value obtained by subtracting the minimum horizontal component of the adjacent motion vectors from the maximum horizontal component and SR.

17. The apparatus of claim 15, wherein the horizontal search line length is shorter as correlations between the adjacent motion vectors are higher and the horizontal search line length is longer as the correlations are lower.

18. The apparatus of claim 15, wherein the horizontal search line length is represented by the equation below
h_size=min((max_{—}xx+D),SR);
wherein max_xx denotes a maximum value of horizontal components of adjacent motion vectors based on a 16×16 block size, min_xx denotes the minimum value of the horizontal components of the adjacent motion vectors, and SR denotes a horizontal search window size, h_size comprises an element for determining a horizontal search line length as a smaller value between a value obtained by adding an offset D to a half of a value obtained by subtracting the minimum horizontal component of the adjacent motion vectors from the maximum horizontal component and SR.

19. The method of claim 13, wherein the search unit performs the search from left to right by copying at least one horizontal line from the off-chip memory to an on-chip memory.

20. The apparatus of claim 13, wherein the search unit calculates SADs at a location horizontally moved by 1 pixel in the on-chip memory after calculating the SADs of the current macro block.
